(19) United States
(12) Patent Application Publication
(10) Pub. No.: US 2020/0026676 A1
(43) Pub. Date: Jan. 23, 2020

(54) USB EXPANSION FUNCTION DEVICE

(71) Applicant: Norel Systems Limited, TIANJIN (CN)

(72) Inventors: Wei ZHAO, TIANJIN (CN); Rui ZHU, TIANJIN (CN); Ting WU, TIANJIN (CN); Lulu XU, TIANJIN (CN); Yuanlong WANG, TIANJIN (CN)

(21) Appl. No.: 16/512,723

(22) Filed: Jul. 16, 2019

(30) Foreign Application Priority Data
Jul. 17, 2018 (CN) 201810781621.6

(51) Int. Cl. G06F 13/40; G06F 13/42

(52) U.S. Cl. CPC G06F 13/4022; G06F 2213/0042; G06F 13/4282

(57) ABSTRACT

The present invention discloses a USB expansion function device. When the USB expansion function device with batteries is connected to a mobile terminal device that needs to be charged, by limiting a charging current through a current limiter, a data communication function of the USB expansion function device connected to the mobile terminal device in a USB host mode is implemented while low power consumption of the batteries inside the USB expansion function device is ensured. Thus, the USB expansion function device with batteries can operate continuously for a long time, and its compatibility with data connection of the mobile terminal device can be improved.

### RELATED APPLICATIONS

This application claims priority to China Application Serial Number 201810781621.6, filed on Jul. 17, 2018, which is incorporated by reference herein in its entirety.

### TECHNICAL FIELD

The present invention relates to a USB expansion function device, and in particular, to that by limiting a charging current through a current limiter, a data communication function of the USB expansion function device to a mobile terminal device connected thereto is implemented while the batteries inside the USB expansion function device are ensured to operate in a low power consumption state.

### BACKGROUND

With the widespread use of mobile terminal devices, the demand for USB expansion function devices connected to mobile terminal devices is also increasing greatly, and the compatibility between a USB expansion function device and a mobile terminal device to be connected has become an urgent problem to be solved. An existing solution at present is generally that a USB expansion function device conducts data connection with a mobile terminal device in a USB OTG mode. In this case, the USB expansion function device serves as a USB device terminal while the mobile terminal device serves as a USB host terminal. At the same time of data connection, the mobile terminal device may supply power for the USB expansion function device through VBUS. This solution has a disadvantage that there are a variety of mobile terminal device manufacturers at present, which have their own solutions; many mobile terminal devices disable the USB OTG mode, or the compatibility of the USB OTG data connection mode is not good, so the USB expansion function device using this solution cannot be compatible with all mobile terminal devices and often cannot be used. Since there is no compatibility problem when all mobile terminal devices are connected to a PC host, the compatibility problem can be solved if the USB expansion function device serving as a USB host terminal is connected to the mobile terminal device serving as a USB device terminal. However, when data connection is carried out in this mode, the USB expansion function device serving as a USB host terminal will charge the mobile terminal device serving as a USB device terminal through VBUS, which will result in that the USB expansion function device requires a long-time large current power supply capability, increasing the size and cost of the USB expansion function device. In conclusion, if it is intended to simplify the design and reduce the size of the USB expansion function device while ensuring the compatibility thereof, a current-limiting data connection solution is required.

### SUMMARY

The technical problem to be solved in the present invention is how to improve the compatibility and ensure that batteries inside the USB expansion function device operate in a low power consumption state when a data communication function between the USB expansion function device and a mobile terminal device is implemented, so as to reduce the requirements on the battery capacity and reduce the size and cost of the device.

In order to solve the above problem, the present invention adopts the following technical solution. A USB expansion function device according to the present invention includes a USB interface, through which the USB expansion function device is connected to a mobile terminal device, and the USB expansion function device further includes a USB host controller, a battery and charging-discharging controller, and a current limiter,

the USB host controller is connected to a USB interface data signal and conducts USB data communication with the mobile terminal device, the USB host controller operates in a USB host mode, and the mobile terminal device operates in a USB device mode, and

the battery and charging-discharging controller supplies power for the USB host controller, and outputs voltage to a USB interface VBUS signal through the current limiter.

Preferably, the current limiter is a resistor.

Further, the current limiter further includes a current-limiting control end that is connected to the battery and charging-discharging controller or the USB host controller, the battery and charging-discharging controller or the USB host controller controls the resistance value of the resistor through the current-limiting control end, and the resistance value includes a resistance value of 0, that is, the current is not limited.

Preferably, the current limiter is an integrated circuit chip.

Preferably, the current limiter further includes a current-limiting control end that is connected to the battery and charging-discharging controller or the USB host controller, and the battery and charging-discharging controller or the USB host controller controls, through the current-limiting control end, whether the current limiter limits the current and limits the magnitude of the current.

Preferably, the USB host controller conducts data communication with a mobile terminal device according to a USB AOA protocol.

The present invention has the following beneficial effects.

According to a USB expansion function device in the present invention, by limiting a charging current through a current limiter, a data connection function of the USB expansion function device operating in a USB host mode to a mobile terminal device operating in a USB device mode is implemented while low power consumption of batteries inside the USB expansion function device is ensured, which implements long-time data connection communication between the USB expansion function device and the mobile terminal device under good compatibility conditions, simplifies the design of the USB expansion function device, avoids the demand for large-capacity batteries, and reduces the size and cost.

### BRIEF DESCRIPTION OF DRAWINGS

FIG. 1 is a schematic module and application diagram of a USB expansion function device according to the present invention.

FIG. 2 is a schematic module and application diagram of Embodiment 1 of a current limiter included in a USB expansion function device according to the present invention.

FIG. 3 is a schematic module and application diagram of Embodiment 2 of a current limiter included in a USB expansion function device according to the present invention.

In the drawings,
1 USB expansion function device
2 mobile terminal device
11 USB host controller
12 current limiter
13 battery and charging-discharging controller
14 USB interface
15 USB interface VBUS
16 USB interface data signal
17 power output line from the battery and charging-discharging controller to the current limiter
18 power output line from the battery and charging-discharging controller to the USB host controller
19 charging input line of the battery and charging-discharging controller
121 current limiter input end
122 current limiter output end
123 current limiter current-limiting control end

### DESCRIPTION OF EMBODIMENTS

A USB expansion function device in the present invention is further described below in combination with embodiments in the drawings.

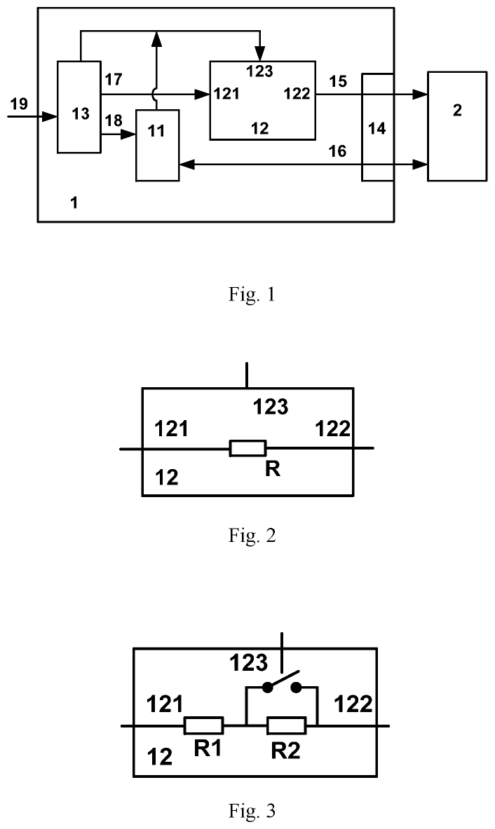

As shown in FIG. 1, in an embodiment of the present invention, a USB expansion function device 1 is connected to a mobile terminal device 2 through a USB interface 14. The USB expansion function device 1 includes a USB host controller 11, a current limiter 12, and a battery and charging-discharging controller 13. A charging input line 19 of the battery and charging-discharging controller is connected to a charging input end of the battery and charging-discharging controller 13 to charge batteries. The battery and charging-discharging controller 13 supplies power for the USB host controller 11 through a power output line 18 from the battery and charging-discharging controller to the USB host controller. The battery and charging-discharging controller 13 is connected to a current limiter input end 121 of the current limiter 12 through a power output line 17 from the battery and charging-discharging controller to the current limiter. The current limiter output end 122 after current limiting by the current limiter 2 is connected to a USB interface VBUS 15, and finally provides power for the mobile terminal device 2.

A USB interface data signal 16 of the USB host controller 11 is connected to the mobile terminal device 2 through the USB interface 14. The USB host controller 11 conducts data communication with the mobile terminal device 2 according to a USB AOA protocol. The USB host controller 11 operates in a USB host mode (USB Host), and the mobile terminal device 2 operates in a USB device mode (USB Device). The USB interface 14 may be a USB 2.0 interface or a USB 3.0 interface or USB Type C interface. When the USB interface 14 is a USB 2.0 interface, the USB interface data signal 16 includes DP and DM signals. When the USB interface 14 is a USB 3.0 or USB Type C interface, the USB interface data signal 16 includes DP and DM signals or DP, DM, SSTX+, SSTX−, SSRX+, and SSRX− signals.

A current limiter current-limiting control end 123 of the current limiter 12 is connected to the battery and charging-discharging controller 13 or the USB host controller 11, or to both the battery and charging-discharging controller 13 and the USB host controller 11. The battery and charging-discharging controller 13 or the USB host controller 11 controls, through the current limiter current-limiting control end 123, whether the current limiter limits the current and limits the magnitude of the current.

As shown in FIG. 2, in Embodiment 1 of a current limiter included in a USB expansion function device according to the present invention, a resistor R is connected between the current limiter input end 121 and the current limiter output end 122 of the current limiter 12. The charging current from the USB expansion function device 1 to the mobile terminal device 2 is limited through the current limiting function of the resistor R.

As shown in FIG. 3, in Embodiment 2 of a current limiter included in a USB expansion function device according to the present invention, resistors R1 and R2 are connected in series between the current limiter input end 121 and the current limiter output end 122 of the current limiter 12, and a current-limiting switch controlled by the current limiter current-limiting control end 123 is connected in parallel to the current-limiting resistor R2. Switch-on/switch-off of the current-limiting switch and resistance values of the resistors R1 and R2 are controlled to control whether the current limiter 12 limits the current and limit the magnitude of the current.

More than two resistors may be connected in series between the current limiter input end 121 and the current limiter output end 122 of the current limiter 12, and multiple current-limiting switches are connected in parallel to the resistors. The current-limiting switches are controlled by the current limiter current-limiting control end 123 to implement different current-limiting resistance values.

The resistance value includes a resistance value of 0, that is, the current is not limited.

The current limiter 12 may also be implemented by parallel connection of multiple resistors connected in series to the current-limiting switches, or implemented in the form of an integrated circuit chip or another circuit.

The present invention implements a USB expansion function device. By limiting a charging current through a current limiter, a data connection function of the USB expansion function device operating in a USB host mode to a mobile terminal device operating in a USB device mode is implemented while low power consumption of batteries inside the USB expansion function device is ensured, which implements long-time data connection communication between the USB expansion function device and the mobile terminal device under good compatibility conditions, simplifies the design of the USB expansion function device, avoids the demand for large-capacity batteries, and reduces the size and cost.

The above apparatus is merely a preferred embodiment of the present invention, and is not intended to pose any limitation to the protection scope of the present invention. The protection scope of the present invention should be subject to the content disclosed in the claims. Any simple change, equivalent replacement or decomposition and combination of the above specific implementations according to the technical essence of the present invention still fall within the protection scope of the present invention.

What is claimed is:

1. A USB expansion function device, comprising a USB interface, through which the USB expansion function device is connected to a mobile terminal device, wherein the USB expansion function device further comprises a USB host controller, a battery and charging-discharging controller, and a current limiter,
the USB host controller is connected to a USB interface data signal and conducts USB data communication with the mobile terminal device, the USB host controller operates in a USB host mode, and the mobile terminal device operates in a USB device mode, and
the battery and charging-discharging controller supplies power for the USB host controller, and outputs voltage to a USB interface VBUS signal through the current limiter.

2. The USB expansion function device as described in claim 1, wherein, the current limiter is a resistor.

3. The USB expansion function device as described in claim 2, wherein, the current limiter further comprises a current-limiting control end that is connected to the battery and charging-discharging controller or the USB host controller, the battery and charging-discharging controller or the USB host controller controls the resistance value of the resistor through the current-limiting control end, and the resistance value comprises a resistance value of 0, that is, the current is not limited.

4. The USB expansion function device as described in claim 1, wherein, the current limiter is an integrated circuit chip.

5. The USB expansion function device as described in claim 1, wherein, the current limiter further comprises a current-limiting control end that is connected to the battery and charging-discharging controller or the USB host controller, and the battery and charging-discharging controller or the USB host controller controls, through the current-limiting control end, whether the current limiter limits the current and limits the magnitude of the current.

6. The USB expansion function device as described in claim 1, wherein, the USB host controller conducts data communication with a mobile terminal device according to a USB AOA protocol.
